(19) United States
(12) Patent Application Publication
(10) Pub. No.: US 2024/0296592 A1
(43) Pub. Date: Sep. 5, 2024

(54) ADAPTIVE DEEP-LEARNING BASED PROBABILITY PREDICTION METHOD FOR POINT CLOUD COMPRESSION

(71) Applicant: HUAWEI TECHNOLOGIES CO., LTD., Shenzhen (CN)

(72) Inventors: Kirill Sergeevich Mityagin, Moscow (RU); Roman Igorevich Chernyak, Moscow (RU); Chenxi Tu, Shenzhen (CN)

(21) Appl. No.: 18/649,653

(22) Filed: Apr. 29, 2024

Related U.S. Application Data
(63) Continuation of application No. PCT/RU2021/000468, filed on Oct. 28, 2021.

(51) Int. Cl. G06T 9/00; G06T 9/40

(52) U.S. Cl. CPC G06T 9/002; G06T 9/40

(57) ABSTRACT

A point cloud data coding method and related coding devices are provided. The method comprises: obtaining an N-ary a tree representation of point cloud data; determining probabilities for entropy coding of information associated with of a current node of the tree, including: selecting a neural network, out of two or more pretrained neural networks, according to a level of the current node within the tree, obtaining the probabilities by processing input data related to the current node by the selected neural network; and entropy coding of the information associated with the current node using the determined probabilities.

### CROSS-REFERENCE TO RELATED APPLICATIONS

This application is a continuation of International Application No. PCT/RU2021/000468, filed on Oct. 28, 2021, the disclosure of which is hereby incorporated by reference in its entirety.

### TECHNICAL FIELD

Embodiments of the present disclosure generally relate to the field of point cloud compression.

### BACKGROUND

Emerging immersive media services are capable of providing customers with unprecedented experiences. Representing as omnidirectional videos and 3D point cloud, customers would feel being personally at the scene, personalized viewing perspective and enjoy real-time full interaction. The contents of the immersive media scene may be the shooting of a realistic scene or the synthesis of a virtual scene. Although traditional multimedia applications still play a leading role, the unique immersive presentation and consumption methods of immersive media have attracted tremendous attentions. In the near future, immersive media are expected to form a big market in a variety of areas such as video, games, medical cares and engineering. The technologies for immersive media have increasingly appealed to both the academic and industrial communities. Among various newly proposed content types, 3D point cloud appears to be one of the most prevalent form of media presentation thanks to the fast development of 3D scanning techniques.

Another important revolutionizing area is robotic perception. Robots powered often utilize a plethora of different sensors to perceive and interact with the world. In particular, 3D sensors such as LiDAR and structured light cameras have proven to be crucial for many types of robots, such as self-driving cars, indoor rovers, robot arms, and drones, thanks to their ability to accurately capture the 3D geometry of a scene. These sensors produce a significant amount of data: a single Velodyne HDL-64 LiDAR sensor generates over 100,000 points per sweep, resulting in over 84 billion points per day. This enormous quantity of raw sensor data brings challenges to onboard and off board storage as well as real-time communication. Hence, it is necessary to develop an efficient compression method for 3D point clouds.

### SUMMARY

Embodiments of the present disclosure relate to methods and apparatuses for point cloud data compression using a neural network. Such data may include but is not limited to 3D feature maps.

A first aspect of a point cloud data coding method, the point cloud data coding method comprising: obtaining an N-ary tree representation of point cloud data; determining probabilities for entropy coding of information associated with a current node of the tree, including: selecting a neural network, out of two or more pretrained neural networks, according to a level of the current node within the tree, obtaining the probabilities by processing input data related to the current node by the selected neural network; and entropy coding of the information associated with the current node using the determined probabilities.

The disclosed method may further comprise a step of adding to the compressed data a header, which includes additional parameters or other kind of information to be used by the decompression process.

One of the motivations for using neural networks for data compression is high-efficiency in the tasks related with pattern recognition. The conventional algorithms cannot fully exploit structural dependencies and redundancies for near-optimal data compression. Embodiments of the present disclosure provide a method for utilizing the learning capabilities of a neural network to effectively maximize the compression ability of point cloud data. The method may include two or more pre-trained independent neural networks, wherein each neural network provides an output of prediction of the input data and its probability in accordance with different levels of the partitioning tree.

In a possible implementation form of the method according to the first aspect as such, the selecting step may include: comparing of the level of the current node within the tree with a predefined threshold; selecting a first neural network when said level of the current node exceeds the threshold and selecting a second neural network, different from the first neural network, when said level of the current node does not exceed the threshold.

In a possible implementation form of the method according to any preceding implementation form of the previous aspect or the previous aspect as such, the neural network may include two or more cascaded subnetworks.

In a possible implementation form of the method according to any preceding implementation form of the previous aspect or the previous aspect as such, the processing of input data related to the current node may comprise inputting context information for the current node and/or context information for the parental and/or neighboring nodes of the current node to a first subnetwork, wherein the context information may comprise spatial and/or semantic information.

Here, it should be understood that depending on the tree partitioning, parental nodes and/or neighboring nodes might not always be available for every node. Thus, available parental nodes and/or available neighboring nodes may be comprised when processing input data, here.

In a possible implementation form of the method according to the preceding implementation form of the previous aspect, the spatial information may include spatial location information; and the semantic information may include one or more of parent occupancy, tree level, an occupancy pattern of a subset of spatially neighboring nodes, and octant information.

In a possible implementation form of the method according to any one of the previous two implementation forms of the previous aspect, the method may further comprise determining one or more features for the current node using the context information as an input to a second sub-network.

In a possible implementation form of the method according to the preceding implementation form of the previous aspect, the method may further comprise determining one or more features for the current node using one or more Long Short-Term Memory, LSTM network(s).

In a possible implementation form of the method according to the preceding implementation form of the previous aspect, the method may further comprise determining one or more features for the current node using one or more Multi Layer Perceptron, MLP, network(s).

In a possible implementation form of the method according to the preceding implementation form of the previous aspect, the method may further comprise determining one or more features for the current node using one or more Convolutional Neural Network, CNN network(s).

In a possible implementation form of the method according to the preceding implementation form of the previous aspect, the method may further comprise determining one or more features for the current node using one or more Multi Layer Perceptron, MLP and one or more Long Short-Term Memory, LSTM networks, all of said networks being cascaded in an arbitrary order.

In a possible implementation form of the method according to the preceding implementation form of the previous aspect, the method may further comprise determining one or more features for the current node using one or more MLP networks, one or more LSTM networks, and one or more CNN, all of said networks being cascaded in an arbitrary order.

In a possible implementation form of the method according to any one of the previous five implementation forms of the previous aspect, the method may further comprise classifying the extracted features into probabilities of information associated with the current node of the tree.

In a possible implementation form of the method according to any one of the previous six implementation forms of the previous aspect, the method may further comprise classifying the extracted features is performed by one or more Multi Layer Perceptron, MLP, network(s).

In a possible implementation form of the method according to the preceding implementation form of the previous aspect, the classifying step may include applying of a multi-dimensional softmax layer and obtaining the estimated probabilities as an output of the multi-dimensional softmax layer.

In a possible implementation form of the method according to any one of the previous eight implementation forms of the previous aspect, the symbol associated with the current node may be an occupancy code.

In a possible implementation form of the method according to any one of the preceding implementation forms of the previous aspect or the previous aspect as such, the tree representation may include geometry information.

In a possible implementation form of the method according to any one of the preceding implementation forms of the previous aspect or the previous aspect as such, wherein octree may be used for the tree partitioning based on geometry information.

In a possible implementation form of the method according to any one of the preceding implementation forms of the previous aspect or the previous aspect as such, wherein any of octree, quadtree and/or binary tree or a combination of thereof may be used for the tree partitioning based on geometry information.

In a possible implementation form of the method according to any one of the preceding implementation forms of the previous aspect or the previous aspect as such, selecting a neural network further may further include a predefined number of additional parameters, wherein the parameters may be signaled in a bitstream.

In a possible implementation form of the method according to any one of the preceding implementation forms of the previous aspect or the previous aspect as such, entropy coding of the current node may further comprise performing arithmetic entropy coding of the symbol associated with the current node using the predicted probabilities.

In a possible implementation form of the method according to any one of the preceding implementation forms of the previous aspect or the previous aspect as such, entropy coding of the current node may further comprise performing asymmetric numeral systems, ANS, entropy coding of the symbol associated with the current node using the predicted probabilities.

Embodiments of the present disclosure also provide a second aspect of a computer program product comprising program code for performing the method according to a possible implementation form of the method according to any one of the preceding implementation forms of the first aspect or the first aspect as such, when executed on a computer or a processor.

Embodiments of the present disclosure also provide a third aspect of a device for encoding point cloud data comprising: a module for obtaining an N-ary tree representation of point cloud data; a probability determining module configured to determine probabilities for entropy coding of a current node of the tree, including: selecting a neural network, out of two or more pretrained neural networks, according to a level of the current node within the tree, obtaining the probabilities by processing input data related to the current node by the selected neural network; and entropy coding of the current node using the determined probabilities.

Embodiments of the present disclosure also provide a fourth aspect of a device for decoding point cloud data comprising: a module for obtaining an N-ary tree representation of point cloud data; a probability determining module configured to determine probabilities for entropy coding of a current node of the tree, including: selecting a neural network, out of two or more pretrained neural networks, according to a level of the current node within the tree, obtaining the probabilities by processing input data related to the current node by the selected neural network; and entropy coding of the current node using the determined probabilities.

Embodiments of the present disclosure also provide a further aspect of a device for encoding point cloud data, the device comprising processing circuitry configured to perform steps of the method according to a possible implementation form of the method according to any one of the preceding implementation forms of the first aspect or the first aspect as such.

Embodiments of the present disclosure also provide a further aspect of a device for decoding point cloud data, the device comprising processing circuitry configured to perform steps of the method according to a possible implementation form of the method according to any one of the preceding implementation forms of the first aspect or the first aspect as such.

Embodiments of the present disclosure also provide a further aspect of a non-transitory computer-readable medium carrying a program code which, when executed by a computer device, causes the computer device to perform the method according to a possible implementation form of the method according to any one of the preceding implementation forms of the first aspect or the first aspect as such.

In the previous aspects, a device for decoding may also be termed a decoder device or in short a decoder. Likewise, in the previous aspects, a device for encoding may also be termed an encoder device or in short an encoder. According to an aspect, the decoder device may be implemented by a cloud. In such scenario, some embodiments may provide a good tradeoff between the rate necessary for transmission and the neural network accuracy.

Any of the above-mentioned devices may also be termed apparatuses. Any of the above-mentioned apparatuses may be embodied on an integrated chip.

Any of the above-mentioned embodiments, aspects and exemplary implementations forms may be combined.

### BRIEF DESCRIPTION OF THE DRAWINGS

In the following embodiments of the present disclosure are described in more detail with reference to the attached figures and drawings, in which

FIG. 1 is a schematic drawing illustrating a point cloud test model;

FIG. 2 is a schematic drawing illustrating octree construction;

FIG. 3 is a schematic drawing illustrating examples of quadtree partitions of a 3D cube;

FIG. 4 is a schematic drawing illustrating examples of binary tree partitions of a 3D cube;

FIG. 5 is a schematic drawing illustrating a classification layer in a CNN based object classification;

FIG. 6 is a schematic drawing illustrating a schematic representation of an MLP with a single hidden layer;

FIG. 7 is a schematic drawing illustrating a Recurrent Neural network, RNN;

FIG. 8 is a schematic drawing illustrating a Long-Short term memory, LSTM, network;

FIG. 9 is a schematic drawing illustrating a deep-learning based lossless PCC compression scheme;

FIG. 10 illustrates an example of an empirical distribution of a single-child node from octree decomposition setting;

FIG. 11 illustrates examples of adjacent neighbor configuration for 3D voxel representation;

FIG. 12 illustrates an example of aggregation from parental nodes using LSTM;

FIG. 13 illustrates an example of using 3DCNN for neighboring feature aggregation;

FIG. 14 illustrates schematically a probability obtainer for a general compression scheme of a point cloud data coding method according to an embodiment of the present disclosure;

FIG. 15 illustrates schematically a general compression scheme of a point cloud data coding method according to another embodiment of the present disclosure;

FIG. 16 illustrates schematically a general compression scheme including CNN for a point cloud data coding method according to yet a further embodiment of the present disclosure;

FIG. 17 illustrates schematically more details of a dataflow for the embodiment shown in FIG. 15;

FIG. 18 illustrates schematically more details of a dataflow for the embodiment shown in FIG. 16;

FIG. 19 illustrates schematically a sequence of steps of a point cloud data coding method according to an embodiment of the present disclosure;

FIG. 20 illustrates schematically a sequence of steps of a point cloud data coding method according to a further embodiment of the present disclosure;

FIG. 21 illustrates schematically a sequence of steps of a point cloud data coding method according to yet a further embodiment of the present disclosure;

FIG. 22 illustrates schematically a sequence of steps of a point cloud data coding method according to yet a further embodiment of the present disclosure;

FIG. 23 illustrates a flowchart according to an embodiment of the present disclosure;

FIG. 24 illustrates an encoder according to an embodiment of the present disclosure;

FIG. 25 illustrates a decoder according to an embodiment of the present disclosure.

### DESCRIPTION

In the following description, reference is made to the accompanying figures, which form part of the disclosure, and which show, by way of illustration, specific aspects of embodiments of the present disclosure or specific aspects in which embodiments of the present disclosure may be used. It is understood that embodiments of the present disclosure may be used in other aspects and comprise structural or logical changes not depicted in the figures. The following detailed description, therefore, is not to be taken in a limiting sense, and the scope of the invention is defined by the appended claims.

For instance, it is understood that a disclosure in connection with a described method may also hold true for a corresponding device or system configured to perform the method and vice versa. For example, if one or a plurality of specific method steps are described, a corresponding device may include one or a plurality of units, e.g. functional units, to perform the described one or plurality of method steps, e.g. one unit performing the one or plurality of steps, or a plurality of units each performing one or more of the plurality of steps, even if such one or more units are not explicitly described or illustrated in the figures. On the other hand, for example, if a specific apparatus is described based on one or a plurality of units, e.g. functional units, a corresponding method may include one step to perform the functionality of the one or plurality of units, e.g. one step performing the functionality of the one or plurality of units, or a plurality of steps each performing the functionality of one or more of the plurality of units, even if such one or plurality of steps are not explicitly described or illustrated in the figures. Further, it is understood that the features of the various exemplary embodiments and/or aspects described herein may be combined with each other, unless specifically noted otherwise.

### MPEG Standardization

According to existence for wide range of applications from 3D point cloud data, the MPEG PCC standardization activity had to generate three categories of point cloud test data: static, e.g. many details, millions to billions of points, colors, dynamic, e.g. less point locations, with temporal information, and dynamically acquired, e.g. millions to billions of points, colors, surface normal and reflectance properties attributes.

After the results, three different technologies were chosen as test models for the three different categories targeted:
LIDAR point cloud compression, L-PCC, for dynamically acquired data
Surface point cloud compression for, S-PCC, for static point cloud data
Video-based point cloud compression, V-PCC, for dynamic content

The final standard is planned to propose two classes of solutions:
Video-based, equivalent to V-PCC, appropriate for point sets with a relatively uniform distribution of points
Geometry-based, G-PCC, equivalent to the combination of L-PCC and S-PCC, appropriate for more sparse distributions.

There are accordingly many applications that use point clouds as the preferred data capture format from MPEG PCC standards:

### VR/AR

Dynamic point cloud sequences can provide the user with the capability to see moving content from any viewpoint: a feature that is also referred to as 6 Degrees of Freedom, 6DoF. Such content is often used in virtual/augmented reality, VR/AR, applications. For example, in point cloud visualization applications using mobile devices were presented. Accordingly, by utilizing the available video decoder and GPU resources present in a mobile phone, V-PCC encoded point clouds were decoded and reconstructed in real-time. Subsequently, when combined with an AR framework, e.g. ARCore, ARkit, the point cloud sequence can be overlaid on a real world through a mobile device

### Telecommunication

Because of high compression efficiency, V-PCC enables the transmission of a point cloud video over a band-limited network. It can thus be used for tele-presence applications. For example, a user wearing a head mount display device will be able to interact with the virtual world remotely by sending/receiving point clouds encoded with V-PCC.

### Autonomous Vehicle

Autonomous driving vehicles use point clouds to collect information about the surrounding environment to avoid collisions. Nowadays, to acquire 3D information, multiple visual sensors are mounted on the vehicles. LIDAR sensor is one such example: it captures the surrounding environment as a time-varying sparse point cloud sequence. G-PCC can compress this sparse sequence and therefore help to improve the dataflow inside the vehicle with a light and efficient algorithm.

### World Heritage

For a cultural heritage archive, an object is scanned with a 3D sensor into a high-resolution static point cloud. Many academic/research projects generate high-quality point clouds of historical architecture or objects to preserve them and create digital copies for a virtual world. Laser range scanner or Structure from Motion, SfM, techniques are employed in the content generation process. Additionally, G-PCC can be used to lossless compress the generated point clouds, reducing the storage requirements while preserving the accurate measurements.

### AI-Based PCC Frameworks

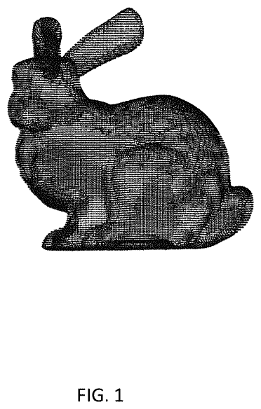

FIG. 1 illustrates a point cloud test model. As illustrated in FIG. 1, a cloud of points in 3D space is typically represented by spatial coordinates (x,y,z) as well as attributes associated with each point such as a color, reflectance, etc. Point clouds allow a surface or volume representation of objects and large scenes as well as their free visualization over six degrees of freedom. They are therefore essential in several fields such as autonomous automobiles, e.g. perception of the environment, virtual reality, augmented reality, immersive communications, etc. Depending on the application, some point clouds can easily reach several million points with complex attributes. Efficient compression of these clouds is therefore essential both for storage and for their transmission through networks or their consumption in memory.

The non-regular nature of point clouds makes it difficult to compress them by using methods traditionally used for regular discrete spaces such as pixel grids. Compression therefore remains a research problem to this day, although some relevant solutions are being standardized by the Moving Picture Expert Group, MPEG, consortium, whether for the compression of dense and dynamic or wide and diffuse attribute point clouds.

Among the coding approaches under study are, e.g., geometry-based point cloud compression, G-PCC, encodes point clouds in their native form using 3D data structures such as density grids, e.g. voxels, octet trees, e.g. octree, or even triangular soups, e.g. polygon soups. In the first two cases, the methods propose solutions to store non-regular point clouds in regular structures. The compression of point clouds is based on deep point cloud compression, DPCC, and is a very recent area of research.

DPPC is an emerging topic that still leaves room for many improvements and model convergence, in particular on how to jointly encode geometry and photometry to improve coding and consumption; how to represent the intrinsic non-regular nature of clouds to allow easy ingestion by learning models, e.g., to use a single point cloud as a point cloud; and how to use a single point cloud to represent the intrinsic non-regular nature of the cloud as a point cloud, using the graph convolutional network based convolutional neural network method; to guide compression via perceptual cost functions adapted to point clouds; to efficiently evolve these techniques when the size of the acquired point cloud increases significantly, e.g., for urban/airborne LIDAR scans, or on how to extend data structures and algorithms to take into account animation.

### Tree Partitioning for Sparse PCC

Point clouds include a set of high dimensional points, typically of 3D, each including 3D position information and additional attributes such as color, reflectance, etc. Unlike 2D image representations, point clouds are characterized by their irregular and sparse distribution across 3D space. Two major issues in PCC are geometry coding and attribute coding. Geometry coding is the compression of 3D positions of a point set, and attribute coding is the compression of attribute values. In state-of-the-art PCC methods, geometry is generally compressed independently from attributes, while the attribute coding is based on the prior knowledge of the reconstructed geometry.

### Octree-Based Point Cloud Coding

In order to deal with irregularly distributed points in 3D space, various decomposition algorithms have been proposed. The most part of existing conventional and DL-based compression frameworks uses octree construction algorithm to process irregular 3D point cloud data. In fact, the hierarchical tree data structure can effectively describe sparse 3D information. Octree based compression is the most widely used method in the literature. An octree is a tree data structure. Each node subdivides the space into eight nodes. For each octree branch node, one bit is used to represent each child node. This configuration can be effectively represented by one byte, which is considered as the occupancy code for corresponding node within octree partitioning.

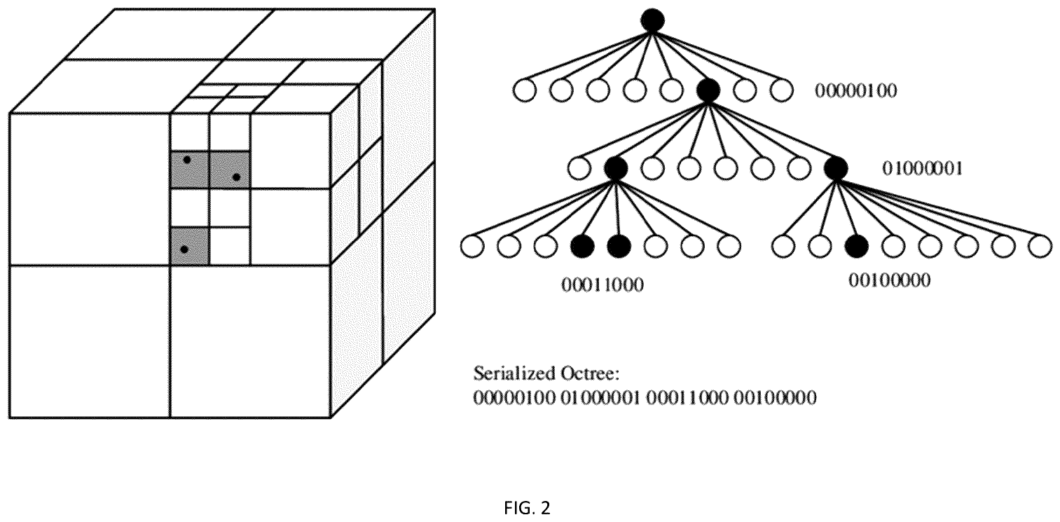

FIG. 2 shows a schematic drawing illustrating octree construction. As illustrated in FIG. 2, for given a point cloud, the corners of the cube, the bounding box of the cube are set to the maximum and minimum values of the input point cloud aligned bounding box B. Then octree structure is then built by recursively subdividing following bounding box B. At each stage, a cube is subdivided into eight sub-cubes. Next, the recursive subdividing is repeated until all leaf nodes include no more than one point. Finally, an octree structure, in which each point is settled, is constructed.

### QTBT Based Point Cloud Coding

Originally, quad-tree plus binary-tree, QTBT, partition is a simple approach that enables asymmetric geometry partition, in a way the codec can handle the asymmetric bounding box for arbitrary point cloud data. Thus, QTBT may achieve significant coding gains on sparse distributed data with minor complexity increase, such as on category LiDAR point cloud data. The gain is from the intrinsic characteristics of such kind of data where the 3D points of the scene are distributed along one or two principle directions. In such case, implicit QTBT can achieve the gains naturally because the tree structure would be imbalanced.

First of all, the bounding box B is not restricted to being a cube; instead, it may be an arbitrary-size rectangular cuboid to better fit for the shape of the 3D scene or objects. In the implementation, the size of B is represented as a power of two, i.e., (2^{dx},2^{dy},2^{dz}). Note that dx, dy and dz are not assumed to be equal; they are signaled separately in the slice header of the bitstream.

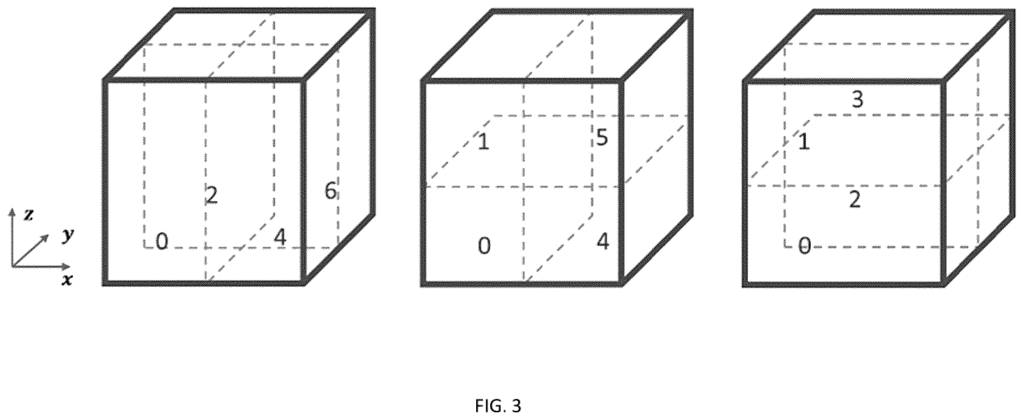

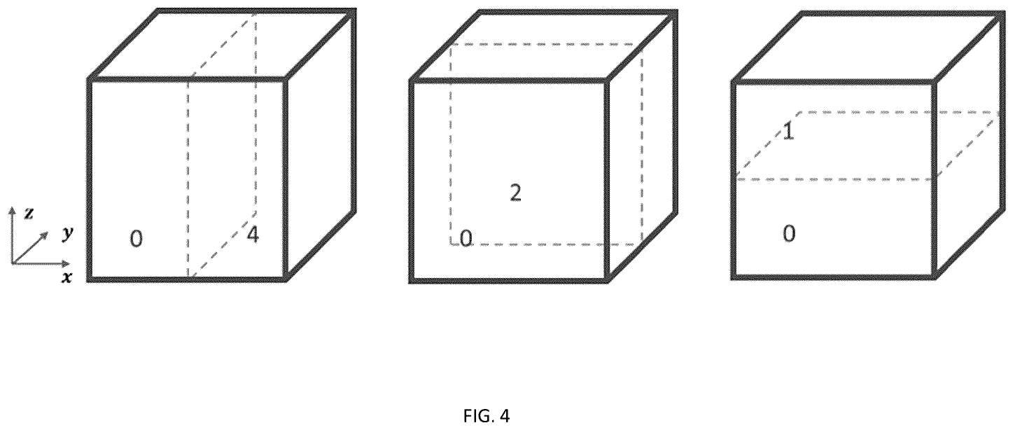

As B may not be a perfect cube, in some cases the node may not be or even cannot be partitioned along all directions. If a partition is performed on all three directions, it is a typical OT partition. If performed on two directions out of three, it is a quad-tree, QT, partition in 3D. If performed on one direction only, it is then a BT partition in 3D. Examples of QT and BT in 3D are shown in FIG. 3 and FIG. 4, respectively. When pre-defined conditions are met, QT and BT partitions can be performed implicitly. Here, “implicitly” implies that no additional signaling bits are needed to indicate that a QT or BT partition, instead of an OT partition, is used. Determining the type and direction of the partition is based on the pre-defined conditions and thus can be decoded without transmitting additional information.

More precisely, a bitstream can be saved from an implicit geometry partition when signaling the occupancy code of each node. A QT partition requires four bits, reducing from eight; to represent the occupancy status of four sub-nodes, while a BT partition only requires two bits. Note that QT and BT partitions can be implemented in the same structure of the OT partition, such that derivation of context information from neighboring coded nodes can be performed in similar ways.

### Neural Networks

This section gives an overview of some used technical terms.

### Artificial Neural Networks

Artificial neural networks, ANN, or connectionist systems are computing systems vaguely inspired by the biological neural networks that constitute animal brains. Such systems “learn” to perform tasks by considering examples, generally without being programmed with task-specific rules. For example, in image recognition, they might learn to identify images that include cats by analyzing example images that have been manually labeled as “cat” or “no cat” and using the results to identify cats in other images. They do this without any prior knowledge of cats, for example, that they have fur, tails, whiskers and cat-like faces. Instead, they automatically generate identifying characteristics from the examples that they process.

An ANN is based on a collection of connected units or nodes called artificial neurons, which loosely model the neurons in a biological brain. Each connection, like the synapses in a biological brain, can transmit a signal to other neurons. An artificial neuron that receives a signal then processes it and can signal neurons connected to it.

In ANN implementations, the “signal” at a connection is a real number, and the output of each neuron is computed by some non-linear function of the sum of its inputs. The connections are called edges. Neurons and edges typically have a weight that adjusts as learning proceeds. The weight increases or decreases the strength of the signal at a connection. Neurons may have a threshold such that a signal is sent only if the aggregate signal crosses that threshold. Typically, neurons are aggregated into layers. Different layers may perform different transformations on their inputs. Signals travel from the first layer, e.g. the input layer, to the last layer, e.g. the output layer, possibly after traversing the layers multiple times.

The original goal of the ANN approach was to solve problems in the same way that a human brain would. Nevertheless, over time, attention moved to performing specific tasks, leading to deviations from biology. ANNs have been used on a variety of tasks, including computer vision, speech recognition, machine translation, social network filtering, playing board and video games, medical diagnosis, and even in activities that have traditionally been considered as reserved to humans, like painting.

### ReLU Layer

ReLU is the abbreviation of rectified linear unit, which applies the non-saturating activation function. It effectively removes negative values from an activation map by setting them to zero. It increases the nonlinear properties of the decision function and of the overall network without affecting the receptive fields of the convolution layer.

Other functions are also used to increase nonlinearity, for example the saturating hyperbolic tangent, and the sigmoid function. ReLU is often preferred to other functions because it trains the neural network several times faster without a significant penalty to generalization accuracy.

### Fully Connected Layer

Fully connected neural networks, FCNNs, are a type of artificial neural network where the architecture is such that all the nodes, or neurons, in one layer are connected to the neurons in the next layer. Neurons in a fully connected layer have connections to all activations in the previous layer, as seen in regular, e.g. non-convolutional, artificial neural networks. Their activations can thus be computed as an affine transformation, with matrix multiplication followed by a bias offset, e.g. vector addition of a learned or fixed bias term.

While this type of algorithm is commonly applied to some types of data, in practice this type of network has some issues in terms of image recognition and classification. Such networks are computationally intense and may be prone to overfitting. When such networks are also ‘deep’, meaning there are many layers of nodes or neurons, they may be particularly difficult for humans to understand.

### Softmax

The softmax function is a generalization of the logistic function to multiple dimensions. It is used in multinomial logistic regression and is often used as the last activation function of a neural network to normalize the output of a network to a probability distribution over predicted output classes, based on Luce's choice axiom.

The softmax function takes as input a vector of real numbers, and normalizes it into a probability distribution consisting of K probabilities proportional to the exponentials of the input numbers. That is, prior to applying softmax, some vector components could be negative, or greater than one; and might not sum to 1; but after applying softmax, each component will be in the interval and the components will add up to 1, so that they can be interpreted as probabilities. Furthermore, the larger input components will correspond to larger probabilities.

### Convolutional Neural Network

The name “convolutional neural network” indicates that the network employs a mathematical operation called convolution. Convolution is a specialized kind of linear operation. Convolutional networks are simply neural networks that use convolution in place of general matrix multiplication in at least one of their layers.

A convolutional neural network consists of an input and an output layer, as well as multiple hidden layers. The hidden layers of a CNN typically consist of a series of convolutional layers that convolve with a multiplication or other dot product. The activation function is commonly a RELU layer, and is subsequently followed by additional convolutions such as pooling layers, fully connected layers and normalization layers, referred to as hidden layers because their inputs and outputs are masked by the activation function and final convolution.

Though the layers are colloquially referred to as convolutions, this is only by convention. Mathematically, it is technically a sliding dot product or cross-correlation. This has significance for the indices in the matrix, in that it affects how weight is determined at a specific index point.

There are different types of convolutions from CNN networks. Most simplistic convolutions are one-dimensional, 1D, convolution are generally used on sequence datasets (but can be used for other use-cases as well). They may be used for extracting local 1D subsequences from the input sequences and identifying local patterns within the window of convolution. Other common uses of 1D convolutions are, e.g. in the area of NLP where every sentence is represented as a sequence of words. For image datasets, mostly two-dimensional, 2D, convolutional filters are used in CNN architectures. The main idea of 2D convolutions is that the convolutional filter typically moves in 2-directions (x,y) to calculate low-dimensional features from the image data. The output shape of the 2D CNN is also a 2D matrix. Three-dimensional, 3D, convolutions apply a three-dimensional filter to the dataset and the filter typically moves 3-direction (x, y, z) to calculate the low-level feature representations. Their output shape of 3D CNN is a 3D volume space such as cube or cuboid. They are helpful in event detection in videos, 3D medical images etc. They are not limited to 3D space but can also be applied to 2D space inputs such as images.

### Multi-Layer Perceptron, MLP

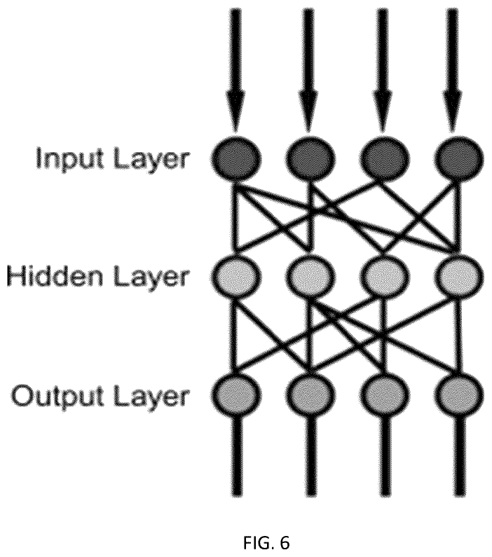

Multi-layer perceptron, MLP, is a supplement of feed forward neural network. It consists of three types of layers—the input layer, output layer and hidden layer, as shown in FIG. 6. FIG. 6 shows a schematic drawing illustrating a schematic representation of an MLP with a single hidden layer. The input layer receives the input signal to be processed. The required task such as prediction and classification is performed by the output layer. An arbitrary number of hidden layers that are placed in between the input and output layer are the true computational engine of the MLP. Similar to a feed forward network in a MLP the data flows in the forward direction from input to output layer. The neurons in the MLP are trained with the back propagation learning algorithm, also known as backpropagation learning algorithm. MLPs are designed to approximate any continuous function and can solve problems that are not linearly separable. The major use cases of MLP are pattern classification, recognition, prediction and approximation.

### Classification Layer

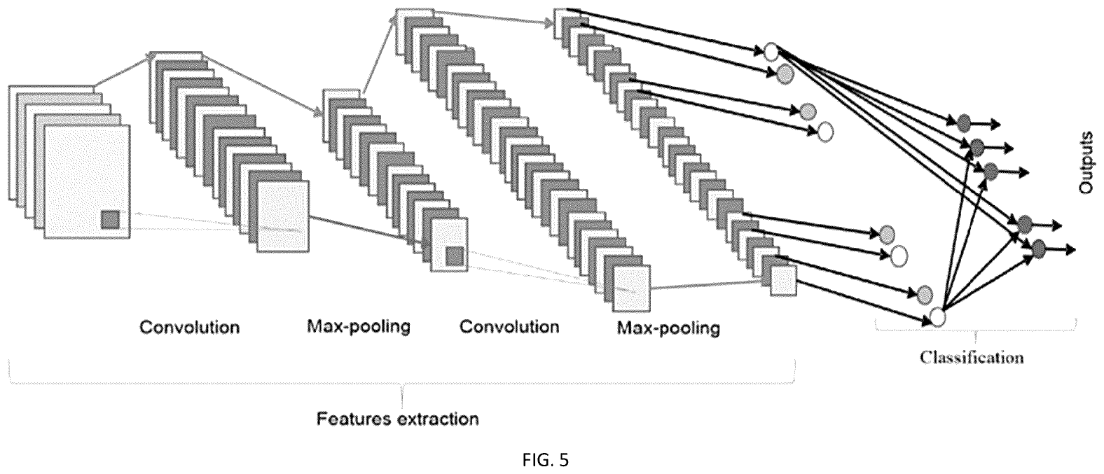

A classification layer computes the cross-entropy loss for classification and weighted classification tasks with mutually exclusive classes. Usually a classification layer is based on a fully connected network or multi-layer perceptron and a softmax activation function for output. Classifier uses the features or feature vector from the output of the previous layer to classify the object from image, cf. FIG. 5, for example. FIG. 5 shows a schematic drawing illustrating a classification layer in a CNN based image classification.

### Recurrent Neural Network

Recurrent neural networks, RNN, are a class of neural networks that is powerful for modeling sequence data such as time series or natural language. Recurrent networks are distinguished from feedforward networks by that feedback loop connected to their past decisions, ingesting their own outputs moment after moment as input. It is often said that recurrent networks have memory. Adding memory to neural networks has a purpose: There is information in the sequence itself, and recurrent nets use it to perform tasks.

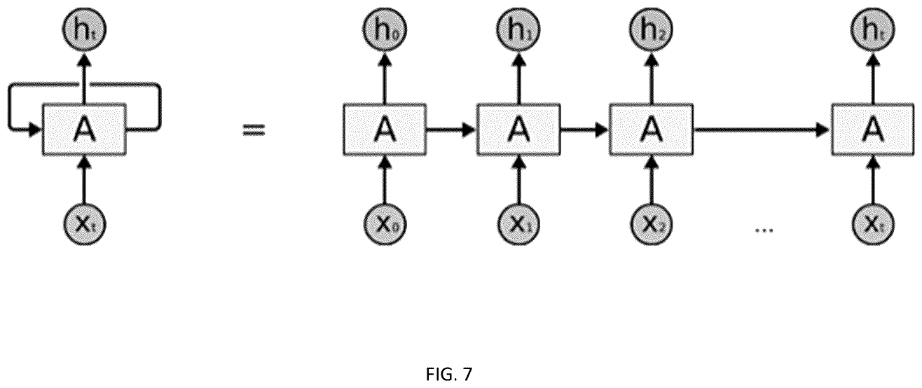

FIG. 7 is a schematic drawing illustrating a recurrent neural network. The sequential information is preserved in the recurrent network's hidden state; cf. FIG. 7, which manages to span many time steps as it cascades forward to affect the processing of each new example. It finds correlations between events separated by many moments, and these correlations are called “long-term dependencies”, because an event downstream in time depends upon, and is a function of, one or more events that came before. One way to think about RNNs is this: they are a way to share weights over time.

### Long-Short Term Memory

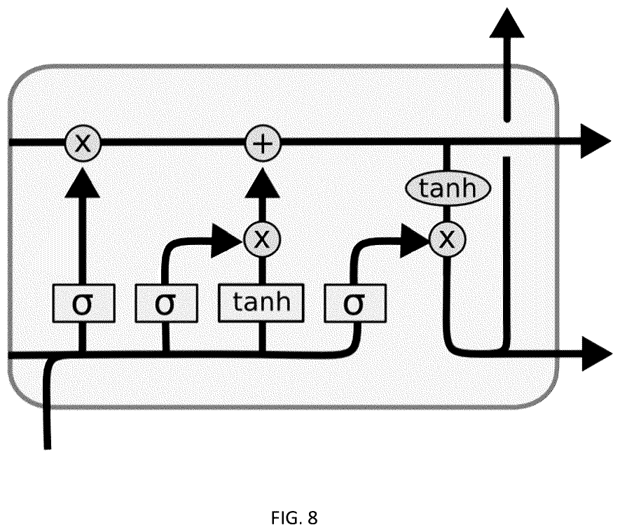

Long Short-Term Memory, LSTM, networks are a type of recurrent neural network capable of learning order dependence in sequence prediction problems, cf. FIG. 8, which is a schematic drawing illustrating a Long-Short term memory, LSTM, network.

This is a behavior required in complex problem domains like machine translation, speech recognition, and more.

LSTM networks include information outside the normal flow of the recurrent network in a gated cell. Information can be stored in, written to, or read from a cell, much like data in a computer's memory. The cell makes decisions about what to store, and when to allow reads, writes and erasures, via gates that open and close. Unlike the digital storage on computers, however, these gates are analog, implemented with element-wise multiplication by sigmoids, which are all in the range of 0-1.

Analog has the advantage over hose gates act on the signals they receive, and similar to the neural network's nodes, they block or pass on information based on its strength and import, which they filter with their own sets of weights. Those weights, like the weights that modulate input and hidden states, are adjusted via the recurrent networks learning process. That is, the cells learn when to allow data to enter, to leave or to be deleted through the iterative process of making guesses, back propagating error, and adjusting weights via gradient descent.er digital of being differentiable, and therefore suitable for backpropagation.

### Sparse Point Cloud Compression

Since LIDAR sensors capture the surrounding environment, point clouds are characterized by their irregular and sparse distribution across 3D space. Originally, hierarchical octree data structure can effectively describe sparse irregular 3D point cloud data. Alternatively, binary and quadtree partitioning can be used for implicit geometry partition for additional bitrate saving.

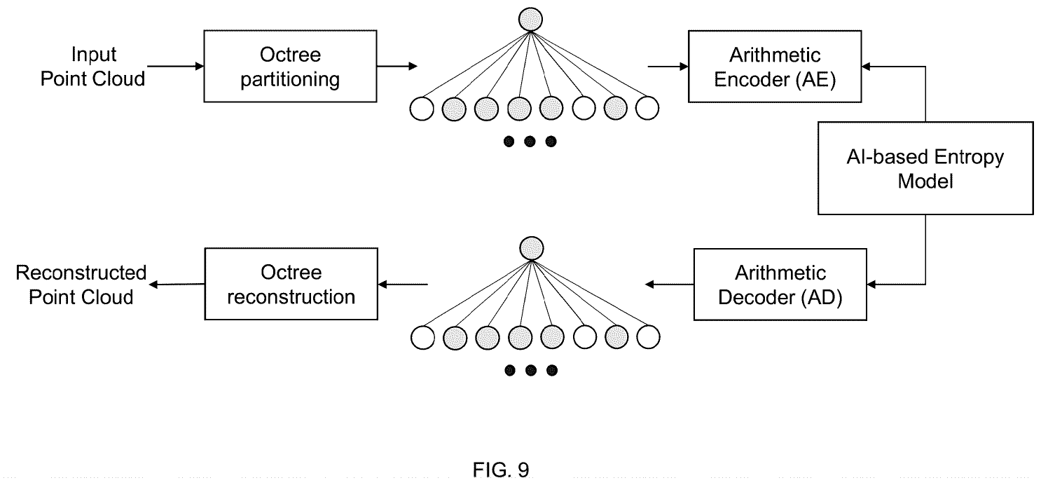

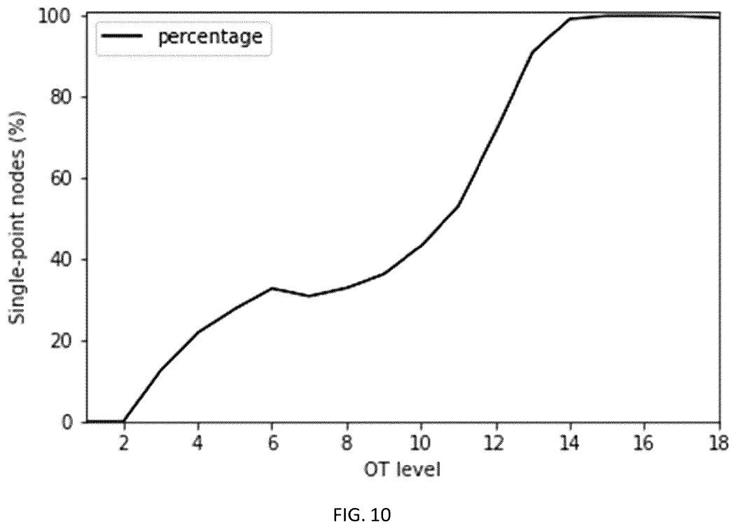

An important observation is that when compressing point clouds using octree, OT, decomposition based compression algorithms, the octree nodes with only one non-empty child, i.e. single-point nodes, occur in an increasing frequency when octree level goes deeper. It is mostly due to sparse nature of point cloud data—for deep tree levels the number of observing points inside become dramatically smaller, cf. FIG. 9 and FIG. 10. FIG. 9 is a schematic drawing illustrating a deep-learning based lossless PCC compression scheme. FIG. 10 shows an example of an empirical distribution of a single-child node from octree decomposition setting.

Thus, further improvement of point cloud coding using trained network architectures may be desirable.

Embodiments of the present disclosure provide an adaptive deep-learning based method for sparse point cloud compression, which predicts probabilities for occupancy code depending on level from the tree partitioning, e.g. octree and/or binary/quadtree can be applied as different tree partitioning strategies. The proposed deep-learning based entropy model comprises three main blocks: embedding, feature extraction and classification.

In this context, the term embeddings should have the same meaning as features. These features or embeddings refer to a respective node or layer of the neural network.

Each main block can be adaptive and performed differently for different tree levels. Since our deep entropy model can be pre-trained effectively offline, the basic idea of this invention is to use neural network training with non-shared weights for each block. That means each tree level can be processed with unique weights that were calculated during the training stage in optimal way. This approach provides a level-dependent flexible way to take into account difference in probability distribution across tree levels and generate a prediction that is more accurate for entropy modeling, which leads to better compression efficiency.

From the partitioning, the octree stores input point cloud by recursively partitioning the input space and storing occupancy in a tree structure. Each intermediate node of the octree includes an 8-bit symbol to store the occupancy of its eight child nodes, with each bit corresponding to a specific child. The resolution increases as the number of levels in the octree increases. The advantage of such a representation is twofold: firstly, only non-empty cells are further subdivided and encoded, which makes the data structure adapt to different levels of sparsity; secondly, the occupancy symbol per node is a tight bit representation.

Using a breadth-first or depth-first traversal, an octree can be serialized into intermediate uncompressed bitstream of occupancy codes. The original tree can be completely reconstructed from these streams. Serialization is a lossless scheme in the sense that occupancy information is exactly preserved. Thus, the only lossy procedure is due to pre-quantization of input point cloud before construction of the octree.

The serialized occupancy bitstream of the octree can be further losslessly encoded into a shorter, compressed bitstream through entropy coding. Entropy encoding is theoretically grounded in information theory. Specifically, an entropy model estimates the probability of occurrence of a given symbol; the probabilities can be adaptive given available context information. A key intuition behind entropy coding is that symbols that are predicted with higher probability can be encoded with fewer bits, achieving higher compression rates.

### Entropy Model

A point cloud of three-dimensional data points may be compressed using an entropy encoder. This is schematically shown in FIG. 9. The input point cloud may be partitioned into an N-ary tree, for example an octree. The representation of the N-ary tree, which may be a serialized occupancy code as described in the example above, may be entropy encoded. Such an entropy encoder is, for example, an arithmetic encoder. The entropy encoder uses an entropy model to encode symbols into a compressed bitstream. At the decoding side, the entropy decoder, which may be, for example an arithmetic decoder, uses also the entropy model to decode the symbol from the compressed bitstream. The N-ary tree may be reconstructed from the decoded symbols. Thus, a reconstructed point cloud is obtained.

Given the sequence of occupancy 8-bit symbols x=[x1, x2, . . . , xn], the goal of an entropy model is to find an estimated distribution q(x) such that it minimizes the cross-entropy with the actual distribution of the symbols p(x). According to Shannon's source coding theorem, the cross-entropy between q(x) and p(x) provides a tight lower bound on the bitrate achievable by arithmetic or range coding algorithms; the better q(x) approximates p(x), the lower the true bitrate.

An entropy model q(x) is the product of conditional probabilities of each individual occupancy symbol xi as follows:

$$q ( x ) = {\prod }_{i} {q}_{i} ( {x}_{i} \vert {x}_{subset ( i )} , {c}_{i} ; w )$$

where: x_{subset(i)}={x_{i,0}, x_{i,1}, . . . , x_{i,K-1}} is the subset of available nodes, parental or neighboring or both, for given node indexed by I (K—size of subset of available nodes), and w denotes the weights from neural network parametrizing our entropy model.

During arithmetic decoding of a given occupancy code on the decoder side, context information such as node depth, parent occupancy, and spatial locations of the current octant are already known given prior knowledge of the traversal format. Here, cᵢ is the context information that is available as prior knowledge during encoding/decoding of xᵢ, such as octant index, spatial location of the octant, level in the octree, parent occupancy, etc. Context information such as location information help to reduce entropy even further by capturing the prior structure of the scene. For instance, in the setting of using LiDAR in the self-driving scenario, an occupancy node 0.5 meters above the LiDAR sensor is unlikely to be occupied. More specifically, the location is a node's 3D location encoded as a vector in R³; the octant is its octant index encoded as an integer in {0, . . . , 7}; the level is its depth in the octree encoded as an integer in {0, . . . , d}; and the parent is its parent's binary 8-bit occupancy code.

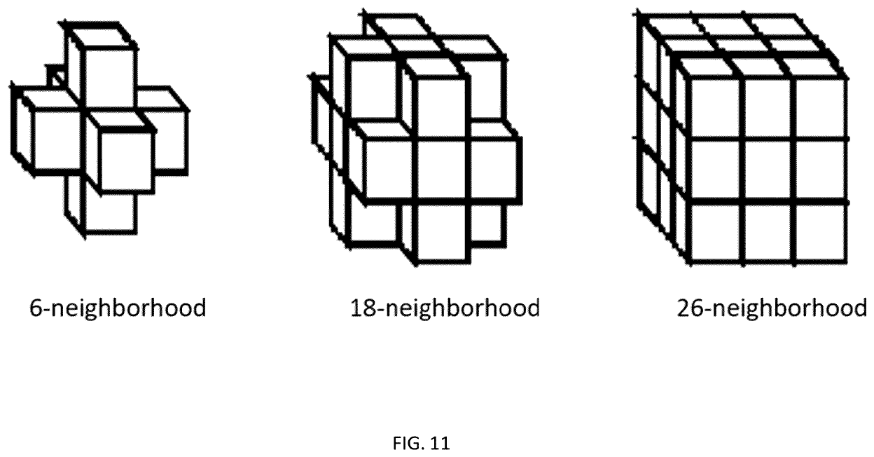

To utilize local geometry information, a configuration with 26 neighbours, e.g. occupancy pattern of a subset of neighboring nodes for a current node may be used as additional context feature, cf. FIG. 11.

Deep entropy model architecture qᵢ(xᵢ|x_{subset(i)},cᵢ;w) firstly extracts an independent contextual embedding for each xᵢ, and then performing progressive aggregation of contextual embeddings to incorporate subset information x_{subset(i)} for a given node i.

Then, final output of entropy model produces a 256-dimensional softmax of probabilities for the 8-bit occupancy symbol.

To extract an independent contextual embeddings for each node, neural network can be applied with the context feature cᵢ as input. The extracted context features, includes both spatial, i.e. xyz and occupancy pattern from 26 neighboring configuration, and semantic, i.e. parent occupancy, level and octant, information. The most appropriate way to process this kind of heterogeneous information is to use multilayer perceptron, MLP. MLP is composed to receive the signal in input layer, an output layer that makes a high-dimensional output, and in between those two, an arbitrary number of hidden layers that are the basic computational engine of the MLP:

$${h}_{i} = MLP ( {c}_{i} )$$

where: hᵢ—computed contextual embedding for given node i.

After computing contextual embeddings i for each node, a subset of another nodes, i.e. parental or neighboring or both, is available due to sequential encoding/decoding process. To extract more information, some kind of aggregation can be performed between the embedding of a current node embedding and the embeddings of a subset of available nodes.

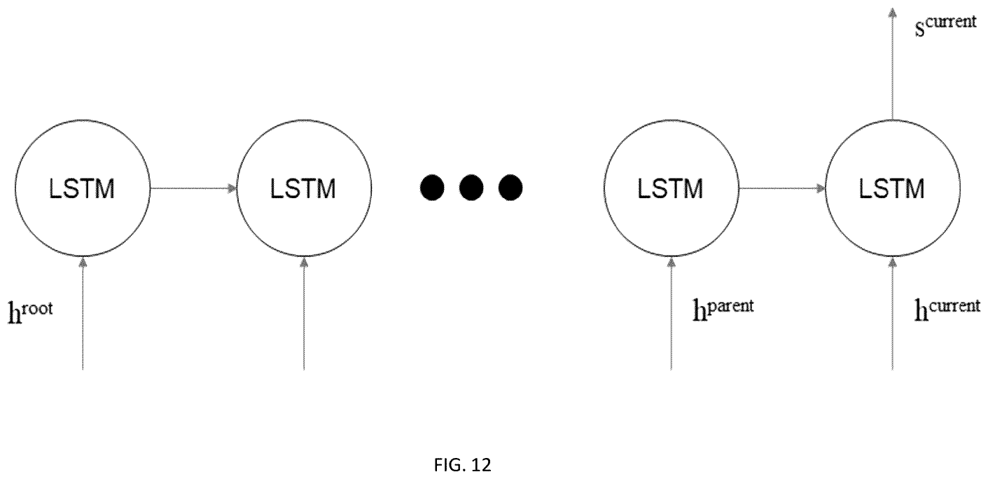

In the case of using parental nodes, the most naive aggregation function is long-short term memory network, cf. FIG. 12. Here, FIG. 12 illustrates parental nodes aggregation with LSTM. Originally, octree partitioning is a top-down approach where information flows from octree root's node down toward intermediate and leaf nodes. In this case, parental nodes, e.g. parent, grandparent and so on, can help to reduce the entropy for the current node prediction, since it is easier to predict the finer geometry structure at the current node when the coarse structure represented by parental nodes which is already known from tree construction process.

To perform progressive aggregation from parental nodes, long short-term memory, LSTM, network utilizes an sequence from contextual embeddings (h^{parent}, . . . , h^{root}) of parental nodes, FIG. 12. LSTM network is able to process sequences of arbitrary length via the recursive application of a transition function on a hidden state vector s^{t}. At each octree level t, the hidden state s^{t} is a function of the deep contextual vector h^{t} that the network receives at step t and its previous hidden state h^{t-1}. The hidden state vector in an LSTM unit is therefore a gated, partial view of the state of the unit's internal memory cell.

In the case of using neighboring nodes, the most appropriate choice is to use 3D convolutional-based neural network. In the octree structure, the parent node will generate eight children nodes, which is equivalent to bisecting the 3D space along x-axis, y-axis and z-axis. Thus, the partition of the original space at the kth depth level in the octree is equivalent to dividing the corresponding 3D space 2 k times along x-axis, y-axis and z-axis, respectively. Then, voxel representation Vᵢ with the shape of 2 k*2 k*2 k based on the existence of points in each cube can be constructed. The voxel representation Vᵢ can be used as strong prior information to improve the compression performance.

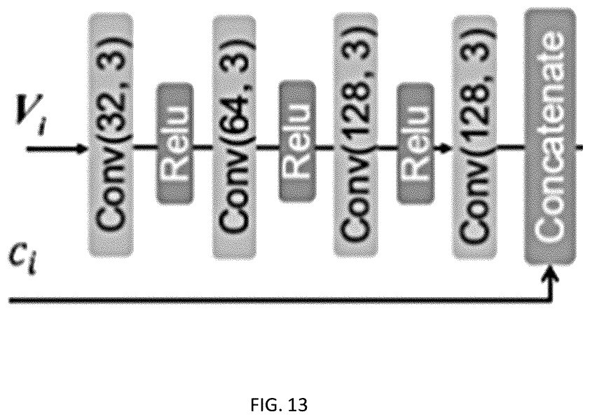

More specifically, for the current node i local voxel context Vi is extracted as a subset of available neighboring nodes. Then Vi is fed to a multi-layer convolutional neural network, CNN. In this procedure, CNN structure effectively exploits context information in the 3D space, which. Then residual connection or concatenation between the independent contextual embedding hᵢ and aggregated embedding as output of a 3D CNN is applied to extract final features for classification. FIG. 13 illustrates an example of using a 3DCNN for neighboring feature aggregation.

As a final block in deep entropy model, multi-layers perception, MLPs, is adopted to solve classification task and generate a 256-dimensional output vector, which fuses aggregated feature information. Finally, a softmax layer is used to produce the probabilities of the 8-bit occupancy symbol for each given node i.

### EMBODIMENTS

From the functional view, the deep entropy model can be decomposed intro three main blocks: embedding, feature extraction and classification layer. An important observation is that when compressing point clouds using octree decomposition based compression algorithms, the octree nodes with only one non-empty child, i.e. single-point nodes, occur in an increasing frequency when tree level goes deeper. It is mostly due to sparse nature of point cloud data—for deep levels, the number of observing points inside become dramatically smaller.

Since each functional block in deep entropy model is trainable, non-shared weights for each specific depth can be straightforward solution to adapt and taking into account difference in probability distributions across different levels.

For practical reasons, neural network training for each depth may be redundant, because both encoder and decoder need to store NN weights in memory, i.e. for very deep networks, model size can be very large. One possible solution here is to split depth range to several portions with near the same stable statistical distribution inside each portion, e.g. two portions with bottom and top levels. In this case, both encoder and decoder need to have the same pre-trained models for each portion.

The portion selection can be part of rate-distortion optimization part of codec. In this case, explicit signalling, possibly with network weights, may need to transmit information to the decoder side

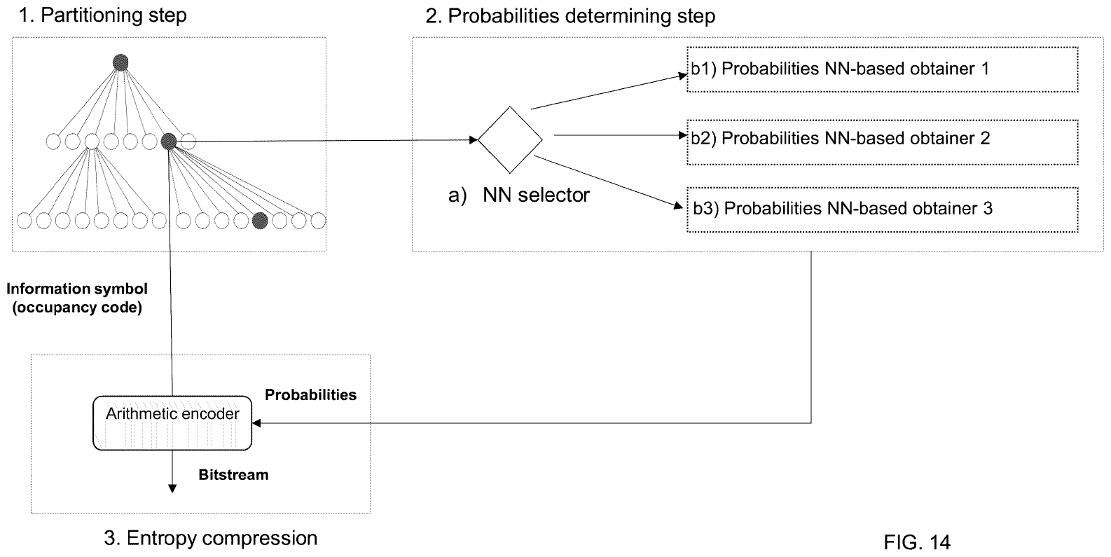

FIG. 14 illustrates schematically a probability obtainer for a compression scheme of a point cloud data coding method according to an embodiment of the present disclosure. In FIG. 14, the method for point cloud compression comprises three blocks. These blocks are as follows: a first block (1) of partitioning, a second block (2) including the determining probabilities using neural networks, NN, and a third block (3) being an entropy coding (compression) block. In more detail, in FIG. 14, the first block indicates a tree partitioning. The tree structure shown is an octree. In general, the tree representation may be an N-ary tree representation. This octree may be similar to the octree described with respect to FIG. 2. Other tree structures like quadtree or binary tree may be used, as well. Thus, in FIG. 14, after obtaining a tree representation, i.e. a structure representing the tree, the method continues to the second block. The second block includes two subblocks. subblock 2a) refers to a selector for a neural network, which may also be denoted as an NN selector. The NN selector may be a switch. The switch may be adaptable. The NN selector is configured to select a neural network. Selecting is made from two or more pretrained neural networks, according to a level of the current node within the tree. The NN selector of subblock 2a) is configured to select a probability obtainer out of a set of probability obtainers. FIG. 14 schematically shows three arrows indicating three possible probability obtainers. These probability obtainers may be denoted b1), b2), b3), or likewise 2b1), 2b2), 2b3). It should be understood that the number of probability obtainers need not be limited to 3. There may be a different number of probability obtainers in the set. The probability obtainers comprised in the set of probability containers are based on neural networks, NN. The probability obtainers perform processing of input data related to the current node by the selected neural network to determine probabilities. The determined probabilities are then used for entropy coding of the current node. Thus, the third block receives the probabilities determined by the second block and includes an encoding module or encoder for entropy coding of the current node.

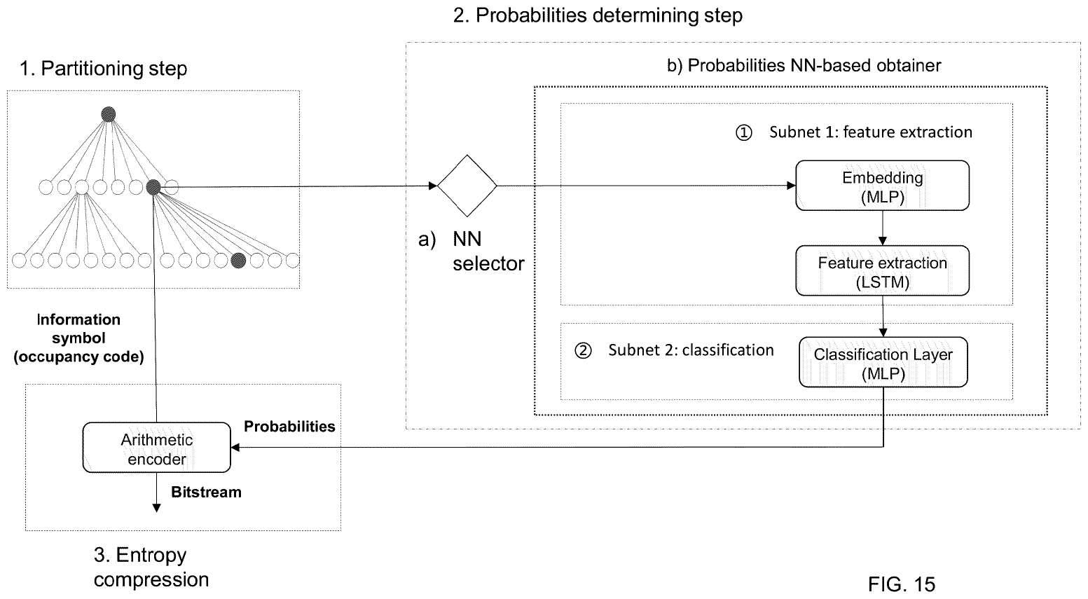

FIG. 15 illustrates schematically a compression scheme of a point cloud data coding method according to another embodiment of the present disclosure. The embodiment illustrated in FIG. 15 is nevertheless similar to the embodiment illustrated in FIG. 14, in that FIG. 15 illustrates three blocks of a method for point cloud compression, as well. These blocks are as follows: a first block (1) of partitioning, a second block (2) including the determining probabilities using neural networks, NN, and a third block (3) being an entropy coding (compression) block. In more detail, the first block (1) of FIG. 15 is a block of partitioning. The tree structure shown is an octree. In general, the tree representation may be an N-ary tree representation. Other tree structures like quadtree or binary tree may be used, as well. Thus, after obtaining a tree representation, i.e. a structure representing the tree, the method continues to the second block. The second block (2) includes two subblocks. Subblock 2a) refers to a selector for a neural network, which may also be denoted as an NN selector. The NN selector is configured to select a neural network. Selecting is made from two or more pretrained neural networks, according to a level of the current node within the tree. The NN selector, cf. outer dashed lines of FIG. 15, of block 2a) is configured to select a probability obtainer, block 2b). The probability obtainer may include two or more subnets, i.e. sub neural networks. As an example, FIG. 15 illustrates two sub neural networks. Here, one neural network (subnet 1) is for feature extraction, the other subnet (subnet 2) is for classification of extracted features into probabilities. The first subnet is configured to extract features for the input data received using multilayer perceptron, MLP, followed by applying LSTM. The second subnet is configured to classify the extracted features from first subnet intro probabilities using MLP. Thereby, probabilities are obtained. The output of the second block, e.g. the probabilities determined are then transmitted to the third block. The third block, i.e. an entropy coding block, is similar to the third block of FIG. 14.

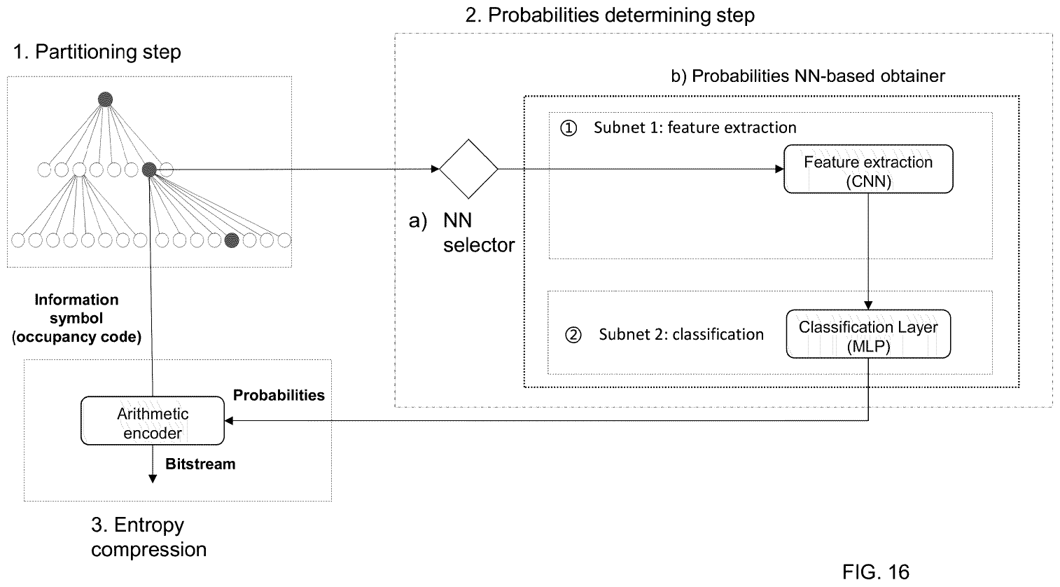

FIG. 16 illustrates a sequence of steps of a point cloud data coding method according to yet a further embodiment of the present disclosure. The embodiment illustrated in FIG. 16 is similar to those of FIG. 14 and FIG. 15. These blocks are as follows: a first block (1) of partitioning, a second block (2) including the determining probabilities using neural networks, NN, and a third block (3) being an entropy coding (compression) block. Looking at FIG. 16 in more detail, however, in the second block, FIG. 16 illustrates schematically a general compression scheme including CNN for extracting features. Thus, the embodiment shown in FIG. 16 includes using a CNN based neural network for feature extraction as an alternative to multilayer perceptron, MLP, followed by applying LSTM, as in the previous embodiments. The remaining steps are similar to those of FIG. 14 and FIG. 15.

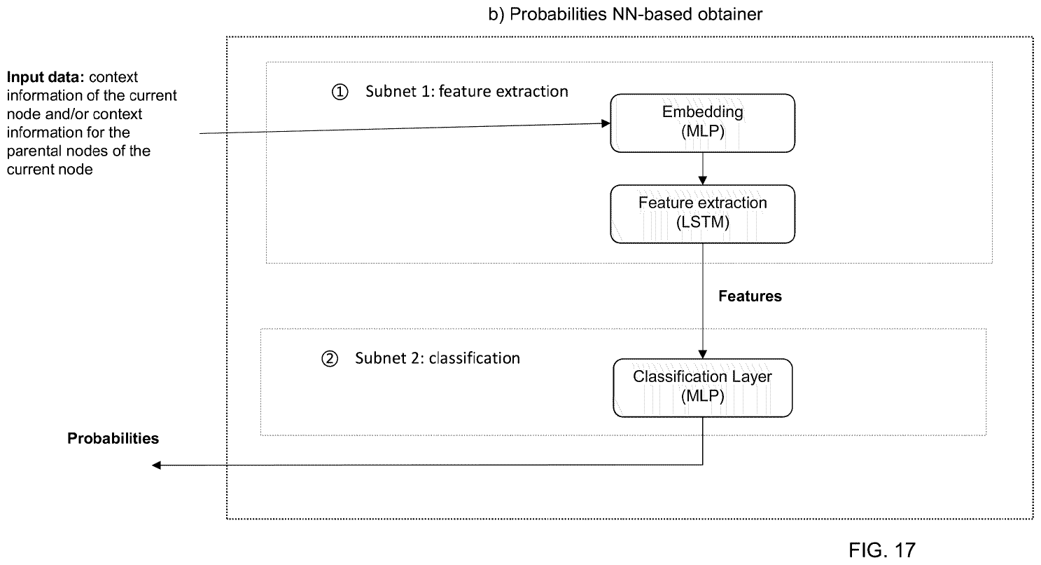

FIG. 17 illustrates schematically more details of a dataflow for the embodiment of FIG. 15. FIG. 17 illustrates that input data for the second block of FIG. 15 may include context information for the current node and/or context information for the parental nodes of the current node, wherein the context information comprises spatial and/or semantic information. These may include xyz coordinates, octant, depth, parent occupancy etc. The remaining features of the embodiment of FIG. 17 may be similar to those of the embodiment of FIG. 15.

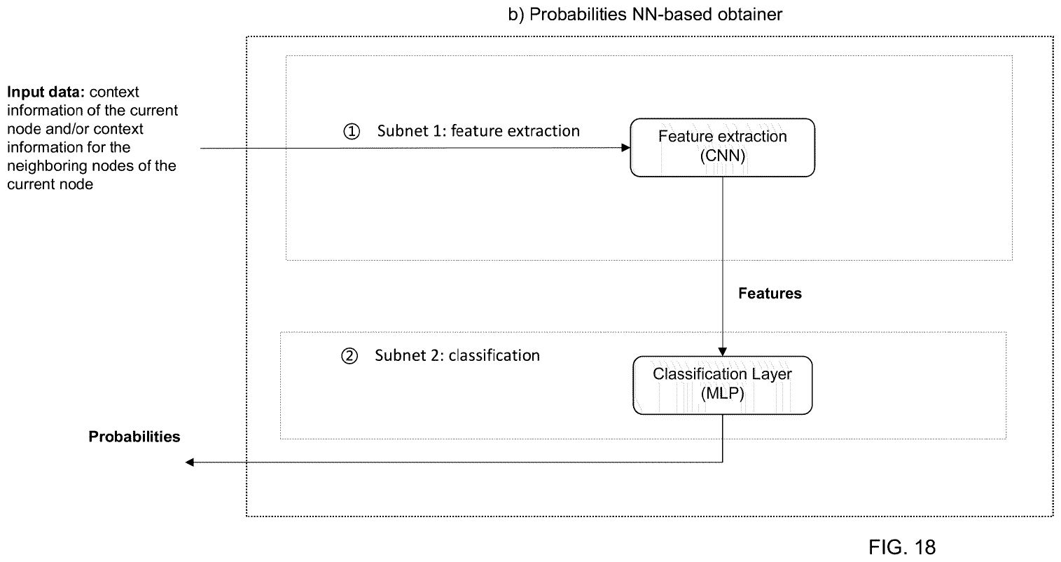

FIG. 18 Illustrates schematically more details of a dataflow for the embodiment of FIG. 16. FIG. 16 illustrates that input data for the second block of FIG. 16. FIG. 18 illustrates that the input data for the second block of FIG. 16 may include context information of the current node and/or context information for the neighboring nodes of the current node. These may include xyz coordinates, octant, depth, parent occupancy etc. The remaining features of the embodiment of FIG. 18 may be similar to those of the embodiment of FIG. 16.

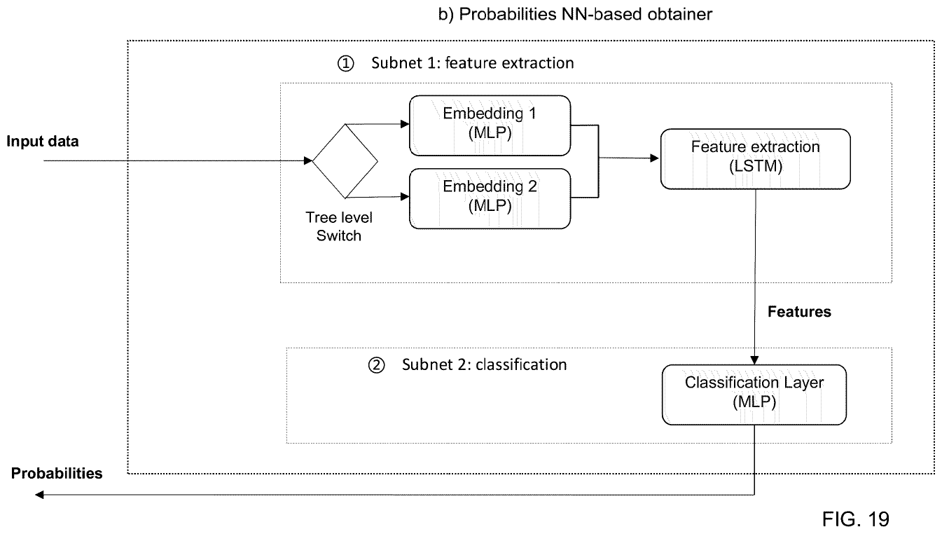

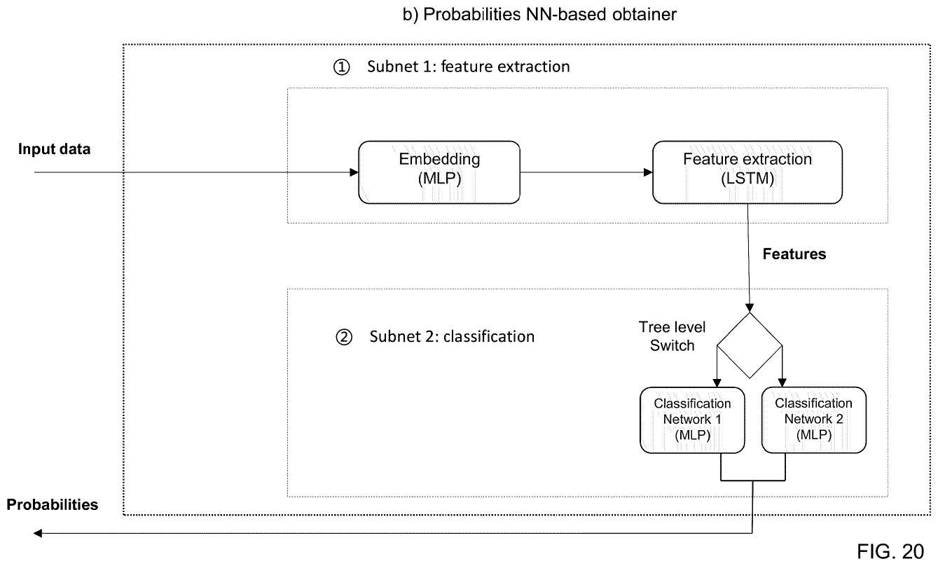

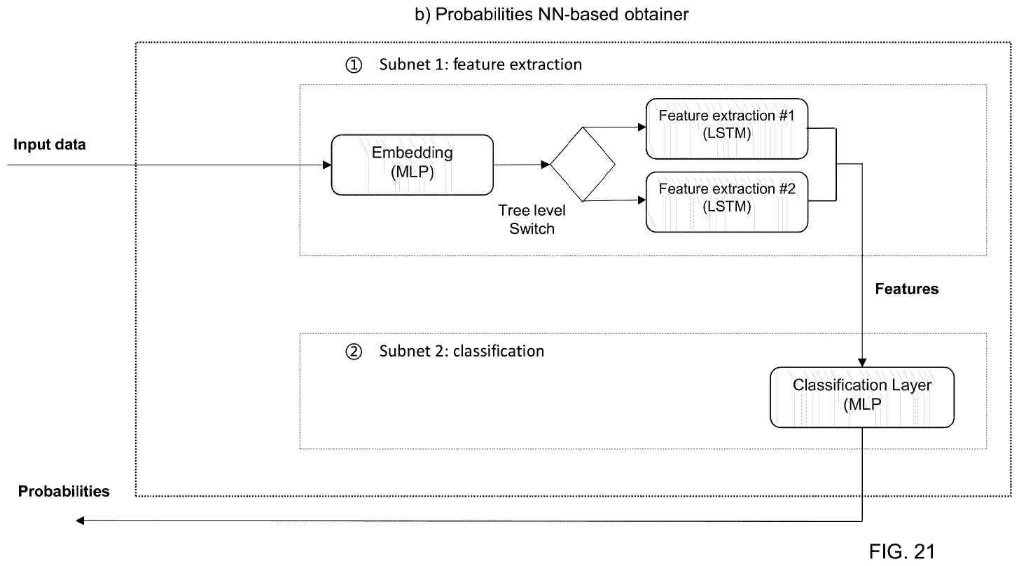

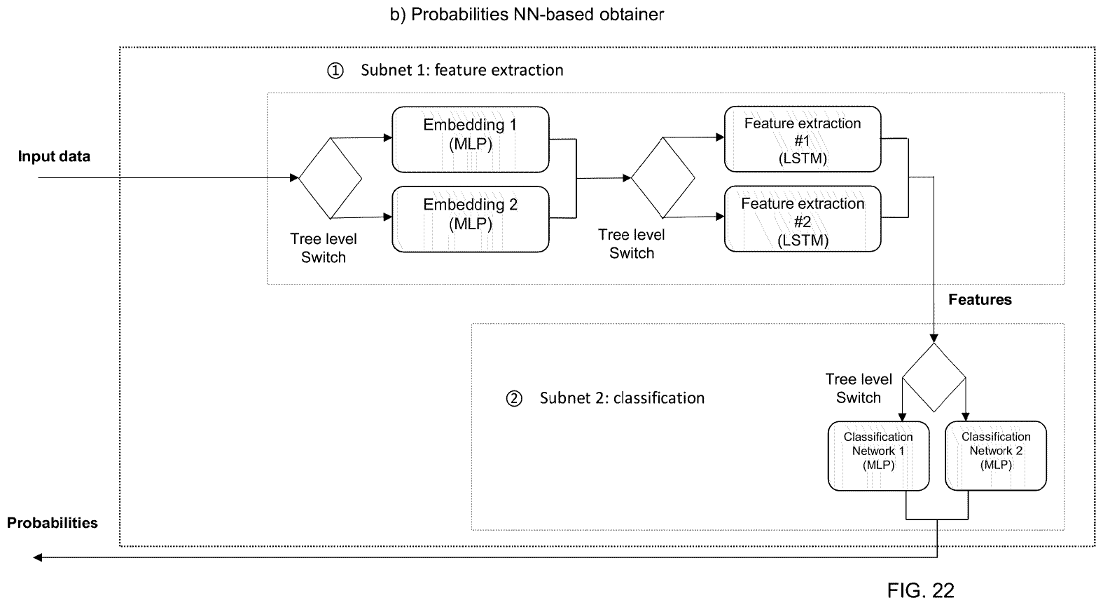

The following figures illustrate embodiments similar to those of the previous figures, however in more detail. In the following figures, i.e. FIG. 19, FIG. 20, FIG. 21, and FIG. 22, the respectively illustrated methods comprise a first step of receiving input data from a partitioning step; cf. the partitioning step illustrated in FIGS. 14, 15 and 16. Thus, FIGS. 19, 20, 21 and 22 illustrate the probability determining step with regard to FIGS. 14, 15, and 16.

FIG. 19 illustrates schematically a sequence of steps of a point cloud data coding method according to an embodiment of the present disclosure.

In the first embodiment i.e. FIG. 19, adaptiveness relates to the first subnet (Subnet 1). In FIG. 19, a first subnet (Subnet 1) and a second subnet (Subnet 2) are shown.

In more detail, in FIG. 19, adaptiveness relates to the embedding part of the first subnet. FIG. 19 further illustrates that there are two MLP sections in the first subnet, which include non-shared weights MLPs that are pre-trained for each specific depth or depth portions. It should be understood that there might be more than two MLPs involved. For implementation, adaptive switching is used which is based on tree depth value. FIG. 19 illustrates a tree level switch for adaptive switching. The tree level switch is in the first subnet. The tree level switch precedes the MLPs. The switch may select which of the MLP(s) should be used. The switching criteria can be consistent with decoder and have not to be transmitted; otherwise signaling is required to transmit this information to decoder. The MLP sections are followed by one more feature extraction sections, e.g. LSTM, as illustrated in FIG. 19. FIG. 19 further illustrates a second subnet (Subnet 2) for classification. Here, classification relates to the results of the feature extraction, LSTM, of the first subnet (Subnet 1). The classification layer as illustrated in FIG. 19 uses one or more MLPs. The result of the classification step is then transmitted for probability determining, cf. FIGS. 14, 15 and 16.

In the second embodiment i.e. FIG. 20, adaptiveness relates to the classification block, i.e. it relates to the second subnet (Subnet 2). In FIG. 20, a first subnet (Subnet 1) and a second subnet (Subnet 2) are shown.

In FIG. 20, the first subnet (Subnet 1) includes an MLP section (embedding) following by a feature extraction section (LSTM). Thus, the first subnet of FIG. 20 is similar to the first subnet of FIG. 19 but without a tree level switch for switching between several MLPs.

In FIG. 20, there are two non-shared weights MLP sections in the second subnet that are pre-trained for each specific depth or depth portions. It should be understood that there might be more than two MLPs involved. For implementation, adaptive switching is used which is based on tree depth value. FIG. 20 illustrates a tree level switch for adaptive switching. The tree level switch is in the second subnet. The tree level switch precedes the MLPs. The switch may select which MLP(s) should be used. The switching criteria can be consistent with decoder and have not to be transmitted; otherwise signaling is required to transmit this information to decoder. The result of the classification step is then transmitted for probability determining, cf. FIGS. 14, 15 and 16.

In the third embodiment, i.e. FIG. 21 relates to the first subnet (Subnet 1). In FIG. 21, a first subnet (Subnet 1) and a second subnet (Subnet 2) are shown.

In more detail, in FIG. 21, adaptiveness relates to the feature extraction block (section) of the first subnet. In FIG. 21, the first subnet (Subnet 1) includes an MLP section followed by a feature extraction section. In the feature extraction section, there are two LSTM sections. The two LSTM sections include non-shared weights LSTMs that are pre-trained for each specific depth or depth portions. It should be understood that there might be more than two LSTM sections. For implementation, adaptive switching is used which is based on tree depth value. FIG. 21 illustrates a tree level switch for adaptive switching. The tree level switch is in the first subnet. The tree level switch precedes the LSTMs. The switch may select which of the LSTM(s) should be used. The switching criteria can be consistent with decoder and have not to be transmitted; otherwise signaling is required to transmit this information to decoder. The LSTM sections of the first subnet provide their results to the second subnet (Subnet 2). FIG. 21 illustrates the second subnet (Subnet 2) for classification. Here, classification relates to the results of the feature extraction, i.e. the LSTMs, of the first subnet (Subnet 1). The classification layer as illustrated in FIG. 21 uses one or more MLPs. The result of the classification step is then transmitted for probability determining, cf. FIGS. 14, 15 and 16.

In the fourth embodiment, i.e. FIG. 22, a first subnet (Subnet 1) and a second subnet (Subnet 2) are illustrated. In FIG. 22, adaptiveness relates to all blocks: embedding, feature extraction block and classification. That is, adaptiveness relates to the first subnet as well as to the second subnet. In the first subnet (Subnet 1) of FIG. 22, a first application of adaptiveness relates to the embedding part of the first subnet. Similar to FIG. 19, FIG. 22 further illustrates that there are two MLP sections in the first subnet for the embedding part. These two MLP sections for the embedding part include non-shared weights MLPs that are pre-trained for each specific depth or depth portions. It should be understood that there might be more than two MLPs involved. For implementation of the first application of adaptiveness, adaptive switching is used which is based on tree depth value. FIG. 22 illustrates a tree level switch for adaptive switching for the first application of adaptiveness. The tree level switch is in the first subnet. The tree level switch precedes the MLPs of the embedding part. The switch may select which of the MLP(s) should be used. The switching criteria can be consistent with decoder and have not to be transmitted; otherwise signaling is required to transmit this information to decoder. The MLP sections are followed by one more feature extraction sections, e.g. LSTM. In FIG. 22, a second application of adaptiveness relates to the feature extraction block (section) of the first subnet (Subnet 1). Similar to FIG. 21, in FIG. 22, in the feature extraction section of the first subnet (Subnet 1) there are two LSTM sections. The two LSTM sections include non-shared weights LSTMs that are pre-trained for each specific depth or depth portions. It should be understood that there might be more than two LSTM sections. For implementation, the second application of adaptive switching is used which is based on tree depth value. FIG. 22 illustrates a tree level switch for this second application of adaptive switching. The tree level, i.e. a second tree level switch, is in the first subnet, before the extraction section. The tree level switch precedes the LSTMs. The switch may select which of the LSTM(s) should be used. The switching criteria can be consistent with decoder and have not to be transmitted; otherwise signaling is required to transmit this information to decoder. The LSTM sections of the first subnet provide their results to the second subnet (Subnet 2).

FIG. 22 further illustrates a second subnet (Subnet 2) for classification. Here, classification relates to the results of the feature extraction, LSTM, of the first subnet (Subnet 1). The classification layer as illustrated in FIG. 22 uses one or more MLPs. Similar to FIG. 20, in FIG. 22, there are two non-shared weights MLP sections in the second subnet that are pre-trained for each specific depth or depth portions. Thus, in FIG. 22, there is a third application of adaptiveness; said third application is in the second subnet (Subnet 2). It should be understood that there might be more than two MLPs involved. For implementation, adaptive switching is used which is based on tree depth value. FIG. 22 illustrates a tree level switch, i.e. a third tree level switch, for adaptive switching. The third tree level switch is in the second subnet. This tree level switch precedes the MLPs. The switch may select which MLP(s) should be used for classification. The switching criteria can be consistent with decoder and have not to be transmitted; otherwise signaling is required to transmit this information to decoder. The result of the classification step of FIG. 22 is then transmitted for probability determining, cf. FIGS. 14, 15 and 16.

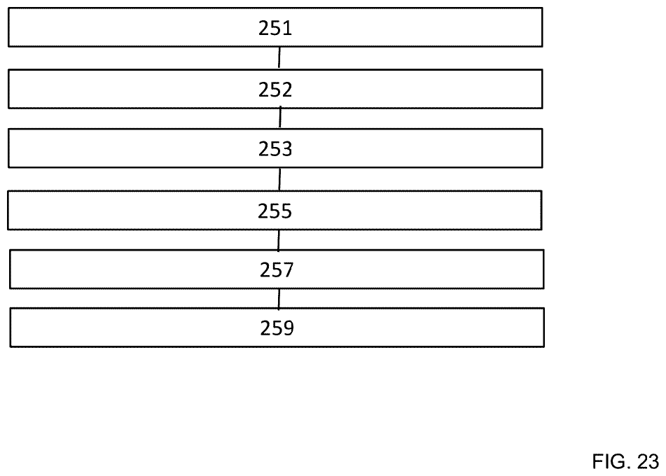

FIG. 23 illustrates another embodiment of the present disclosure: FIG. 23 illustrates a point cloud data coding method comprising the following steps: step 251 of obtaining an N-ary representation of point cloud data; step 252 of collecting input data into buffer, i.e. buffering of the input data; step 253 of determining probabilities for entropy coding of a current node of the tree, including: step 255 of selecting a neural network, out of two or more pretrained neural networks, according to a level of the current node within the tree, step 257 of obtaining the probabilities by processing input data related to the current node, the input data collected in the buffer, by the selected neural network; and step 259 of entropy coding of the current node using the determined probabilities.

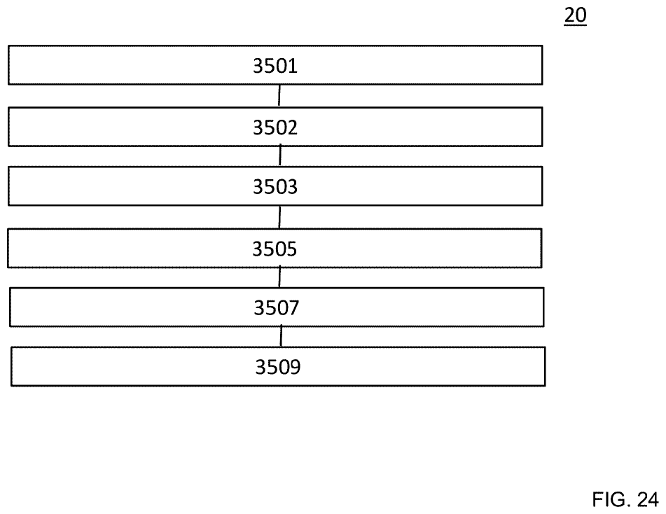

FIG. 24 illustrates an encoder according to an embodiment of the present disclosure: A device for encoding point cloud data, i.e. an encoder 20, is illustrated, the encoder comprising: a module for obtaining an N-ary tree 3501 configured to obtain a tree representation of point cloud data; a module 3502 for collecting input data into buffer, i.e. buffering of the input data; a probability determining module 3503 configured to determine probabilities for entropy coding of a current node of the tree, including: a selector module 3505 for selecting a neural network, out of two or more pretrained neural networks, according to a level of the current node within the tree, an obtainer module 3507 for obtaining the probabilities by processing input data related to the current node, the input data collected in the buffer, by the selected neural network; and an entropy coding module 3509 for entropy coding of the current node using the determined probabilities.

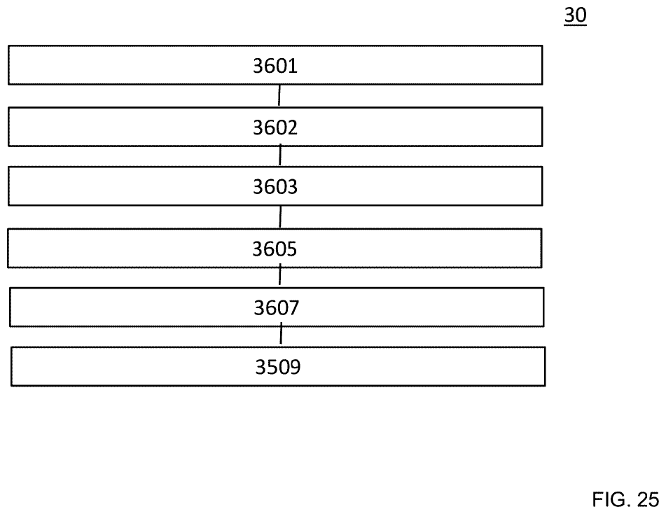

FIG. 25 illustrates a decoder according to an embodiment of the present disclosure: A device for decoding point cloud data, i.e. a decoder 30, is illustrated, the decoder 30 comprising: a module for obtaining an N-ary tree 3601 configured to obtain a tree representation of point cloud data; a module 3602 for collecting input data into buffer, i.e. buffering of the input data; a probability determining module 3603 configured to determine probabilities for entropy coding of a current node of the tree, including: a selector module 3605 for selecting a neural network, out of two or more pretrained neural networks, according to a level of the current node within the tree, an obtainer module 3607 for obtaining the probabilities by processing input data related to the current node, the input data collected in the buffer, by the selected neural network; and an entropy coding module 3609 for coding of the current node using the determined probabilities.

### Mathematical Operators and Symbols

The mathematical operators in the exemplary syntax description used in this application are similar to those used to describe syntax in existing codecs. Numbering and counting conventions generally begin from 0, e.g., “the first” is equivalent to the 0-th, “the second” is equivalent to the 1-th, etc.

The following arithmetic operators are defined as follows:
+ Addition
− Subtraction (as a two-argument operator) or negation (as a unary prefix operator)
* Multiplication, including matrix multiplication
/ Integer division with truncation of the result toward zero. For example, 7/4 and −7/−4 are truncated to 1 and −7/4 and 7/−4 are truncated to −1.
x % y Modulus. Remainder of x divided by y, defined only for integers x and y with x>=0 and y>0.

The following logical operators are defined as follows:
x && y Boolean logical “and” of x and y
x∥y Boolean logical “or” of x and y
! Boolean logical “not”
x?y:z If x is TRUE or not equal to 0, evaluates to the value of y; otherwise, evaluates to the value of z.

The following relational operators are defined as follows:
> Greater than
>= Greater than or equal to
< Less than
<= Less than or equal to
== Equal to
!= Not equal to

When a relational operator is applied to a syntax element or variable that has been assigned the value “na” (not applicable), the value “na” is treated as a distinct value for the syntax element or variable. The value “na” is considered not to be equal to any other value.

The following bit-wise operators are defined as follows:
& Bit-wise “and”. When operating on integer arguments, operates on a two's complement representation of the integer value. When operating on a binary argument that includes fewer bits than another argument, the shorter argument is extended by adding more significant bits equal to 0.
   | Bit-wise “or”. When operating on integer arguments, operates on a two's complement representation of the integer value. When operating on a binary argument that includes fewer bits than another argument, the shorter argument is extended by adding more significant bits equal to 0.
\hat{ } Bit-wise “exclusive or”. When operating on integer arguments, operates on a two's complement representation of the integer value. When operating on a binary argument that includes fewer bits than another argument, the shorter argument is extended by adding more significant bits equal to 0.
x>>y Arithmetic right shift of a two's complement integer representation of x by y binary digits. This function is defined only for non-negative integer values of y. Bits shifted into the most significant bits (MSBs) as a result of the right shift have a value equal to the MSB of x prior to the shift operation.
x<<y Arithmetic left shift of a two's complement integer representation of x by y binary digits. This function is defined only for non-negative integer values of y. Bits shifted into the least significant bits (LSBs) as a result of the left shift have a value equal to 0.

The following arithmetic operators are defined as follows:
= Assignment operator
++ Increment, i.e., x++ is equivalent to x=x+1; when used in an array index, evaluates to the value of the variable prior to the increment operation.
−− Decrement, i.e., x−− is equivalent to x=x−1; when used in an array index, evaluates to the value of the variable prior to the decrement operation.
+= Increment by amount specified, i.e., x+=3 is equivalent to x=x+3, and x+=(−3) is equivalent to x=x+(−3).
−=Decrement by amount specified, i.e., x−=3 is equivalent to x=x−3, and x−=(−3) is equivalent to x=x−(−3).

The following notation is used to specify a range of values:
x=y . . . z x takes on integer values starting from y to z, inclusive, with x, y, and z being integer numbers and z being greater than y.

When an order of precedence in an expression is not indicated explicitly by use of parentheses, the following rules apply:
Operations of a higher precedence are evaluated before any operation of a lower precedence.
Operations of the same precedence are evaluated sequentially from left to right.

The table below specifies the precedence of operations from highest to lowest; a higher position in the table indicates a higher precedence.

For those operators that are also used in the C programming language, the order of precedence used in this Specification is the same as used in the C programming language.

Table: Operation precedence from highest
(at top of table) to lowest (at bottom of table)

operations (with operands x, y, and z)
″x++″, ″x− −″
″!x″, ″−x″ (as a unary prefix operator)
x^{y}
${}^{″} x * {y}^{″} , {}^{″} x / {y}^{″} , {}^{″} x \div {y}^{″} , {\frac{{}^{″} x}{y}}^{″} , {}^{″} x \% {y}^{″}$
″x + y″, ″x −y″ (as a two-argument operator),
${}^{″} {\sum }_{i = x}^{y} {f ( i )}^{″}$
″x << y″, ″x >> y″
″x < y″, ″x <= y″, ″x > y″, ″x >= y″
″x = = y″, ″x != y″
″x & y″
″x | y″
″x && y″
″x ∥ y″
″x ? y : z″
″x..y″
″x = y″, ″x += y″, ″x −= y″

In the text, a statement of logical operations as would be described mathematically in the following form:

if(condition 0)
statement 0

else if(condition 1)
statement 1

. . .

else /* informative remark on remaining condition */
statement n
   may be described in the following manner:

. . . as follows / . . . the following applies:
If condition 0, statement 0
Otherwise, if condition 1, statement 1
. . .
Otherwise (informative remark on remaining condition), statement n

Each “If . . . Otherwise, if . . . Otherwise, . . . ” statement in the text is introduced with “ . . . as follows” or “ . . . the following applies” immediately followed by “If . . . ”. The last condition of the “If . . . Otherwise, if . . . Otherwise, . . . ” is always an “Otherwise, . . . ”. Interleaved “If . . . Otherwise, if . . . Otherwise, . . . ” statements can be identified by matching “ . . . as follows” or “ . . . the following applies” with the ending “Otherwise, . . . ”.

In the text, a statement of logical operations as would be described mathematically in the following form:

if(condition 0a && condition 0b)
statement 0

else if(condition 1a∥condition 1b)
statement 1

. . .

else
statement n
   may be described in the following manner:

. . . as follows / . . . the following applies:
If all of the following conditions are true, statement 0:
   condition 0a
   condition 0b
Otherwise, if one or more of the following conditions are true, statement 1:
   condition 1a
   condition 1b
. . .
Otherwise, statement n

In the text, a statement of logical operations as would be described mathematically in the following form:

if(condition 0)
statement 0

if(condition 1)
statement 1
   may be described in the following manner:
When condition 0, statement 0
When condition 1, statement 1

What is claimed is:

1. A point cloud data coding method applied to an electronic device, the method comprising:
obtaining an N-ary tree representation of point cloud data;
determining probabilities for entropy coding of information associated with a current node of the tree, including:
selecting a neural network, from two or more pretrained neural networks, according to a level of the current node of the tree,
obtaining the probabilities through processing input data related to the current node by the selected neural network; and
entropy coding of the information associated with the current node based on the determined probabilities.

2. The method according to claim 1, wherein the selecting the neural network includes:
comparing of the level of the current node within the tree with a predefined threshold;
selecting a first neural network in response to the level of the current node exceeding the threshold; and
selecting a second neural network, which is different from the first neural network, in response to the level of the current node not exceeding the threshold.

3. The method according to claim 1, wherein the neural network includes two or more cascaded subnetworks.

4. The method according to claim 1, wherein the processing the input data related to the current node comprises: inputting context information for the current node and/or context information for parental and/or neighboring nodes of the current node to a first subnetwork, wherein the context information comprises spatial and/or semantic information.

5. The method according to claim 4, wherein the spatial information includes spatial location information; and wherein the semantic information includes one or more of parent occupancy, tree level, an occupancy pattern of a subset of spatially neighboring nodes, and octant information.

6. The method according to claim 4, further comprising determining one or more features for the current node using the context information as an input to a second subnetwork.

7. The method according to claim 6, further comprising determining one or more features for the current node using one or more Long Short-Term Memory (LSTM) network(s), or
determining one or more features for the current node using one or more Multi Layer Perceptron (MLP) network(s), or
determining one or more features for the current node using one or more Convolutional Neural Network (CNN) network(s), or
determining one or more features for the current node using one or more Multi Layer Perceptron (MLP) and one or more Long Short-Term Memory (LSTM) networks, wherein all of the networks are cascaded in an arbitrary order, or
determining one or more features for the current node using one or more Multi Layer Perceptron (MLP) networks, one or more Long Short-Term Memory (LSTM) networks, and one or more Convolutional Neural Network (CNN), wherein all of the networks are cascaded in an arbitrary order.

8. The method according to claim 7, further comprising classifying the extracted features into probabilities of information associated with the current node of the tree.

9. The method according to claim 7, wherein the classifying the extracted features into probabilities is performed by one or more Multi Layer Perceptron (MLP) network(s), and wherein the classifying the extracted features includes applying of a multi-dimensional softmax layer and obtaining the estimated probabilities as an output of the multi-dimensional softmax layer.

10. The method according to claim 7, wherein the symbol associated with the current node is an occupancy code.

11. The method according to claim 1, wherein the tree representation includes geometry information.

12. The method according to claim 1, wherein octree is used for the tree partitioning based on geometry information.

13. The method according to claim 1, wherein any of octree, quadtree and/or binary tree or a combination of thereof is used for the tree partitioning based on geometry information.

14. The method according to claim 1, wherein the selecting the neural network is further based on a predefined number of additional parameters, wherein the additional parameters are signaled in a bitstream.

15. The method according to claim 1, wherein the entropy coding of the current node further comprises performing arithmetic entropy coding of the symbol associated with the current node using the predicted probabilities.

16. The method according to claim 1, wherein the entropy coding of the current node further comprises performing asymmetric numeral systems (ANS) entropy coding of the symbol associated with the current node using the predicted probabilities.

17. A computer program product comprising program code for performing the method according to claim 1 when executed on a computer or a processor.

18. A device for encoding point cloud data comprising:
a processor; and
a memory, coupled to the processor and having processor-executable instructions stored thereon which upon execution by the processor cause the device to implement the following:
obtaining an N-ary tree representation of point cloud data;
determining probabilities for entropy coding of a current node of the tree, including:
selecting a neural network, from two or more pretrained neural networks, according to a level of the current node of the tree,
obtaining the probabilities through processing input data related to the current node by the selected neural network; and
entropy coding of the current node based on the determined probabilities.

19. A device for decoding point cloud data comprising:
a processor; and
a memory, coupled to the processor and having processor-executable instructions stored thereon which upon execution by the processor cause the device to implement the following:
obtaining an N-ary tree representation of point cloud data;
determining probabilities for entropy coding of a current node of the tree, including:
selecting a neural network, from two or more pretrained neural networks, according to a level of the current node of the tree,
obtaining the probabilities through processing input data related to the current node by the selected neural network; and
entropy coding of the current node based on the determined probabilities.

20. The device according to claim 18, wherein the selecting the neural network includes:
comparing of the level of the current node within the tree with a predefined threshold;
selecting a first neural network in response to the level of the current node exceeding the threshold; and
selecting a second neural network, which is different from the first neural network, in response to the level of the current node not exceeding the threshold.
